(19) United States
(12) Patent Application Publication
(10) Pub. No.: US 2020/0062121 A1
(43) Pub. Date: Feb. 27, 2020

(54) STATE MONITORING DEVICE OF RAILCAR

(71) Applicant: KAWASAKI JUKOGYO KABUSHIKI KAISHA, Kobe-shi, Hyogo (JP)

(72) Inventors: Yoshi SATO, Sanda-shi (JP); Haruyoshi MAEDA, Kobe-shi (JP)

(73) Assignee: KAWASAKI JUKOGYO KABUSHIKI KAISHA, Kobe-shi, Hyogo (JP)

(21) Appl. No.: 16/466,269

(22) PCT Filed: Mar. 14, 2017
(86) PCT No.: PCT/JP2017/010182

§ 371 Date: Jun. 3, 2019

(30) Foreign Application Priority Data
Dec. 1, 2016 (JP) 2016-233872

(51) Int. Cl. B60L 1/00; B60L 3/00; F16C 19/04; F16C 41/00

(52) U.S. Cl. CPC B60L 1/00; B60L 3/0038; B61L 25/021; F16C 41/008; F16C 19/04

(57) ABSTRACT

A state monitoring device of a railcar includes: a monitoring sensor configured to detect state information pieces of a machine part of a bogie; and a wireless transmission unit configured to wirelessly transmit signals at a transmission interval, the signals containing the state information pieces detected by the monitoring sensor. When it is determined that a monitored value based on the state information piece is not more than a threshold, the wireless transmission unit wirelessly transmits the signals at the transmission interval that is a predetermined initial interval. When it is determined that the monitored value has exceeded the threshold, the wireless transmission unit wirelessly transmits the signals at the transmission interval that is a narrow interval narrower than the initial interval.

### TECHNICAL FIELD

The present invention relates to a state monitoring device of a railcar.

### BACKGROUND ART

In order to prevent seizure of a bearing accommodated in an axle box in a bogie of a railcar, it is important to regularly measure the temperature of the bearing, and with this, a sudden operation stop of the railcar is prevented. Known is a technology in which: a temperature sensor is attached to the bearing; and an abnormality of the bearing is detected based on a temperature measured by the temperature sensor (see PTL 1, for example).

### CITATION LIST

### Patent Literature

PTL 1: Japanese Laid-Open Patent Application Publication No. 2010-121639

### SUMMARY OF INVENTION

### Technical Problem

However, according to the railcar, the bogie is displaceable relative to a carbody. When a wire is extended from the carbody to the temperature sensor of the bogie, the wire moves by the deviation of the bogie. Therefore, in order to eliminate the wire between the carbody and the bogie, it may be thought that a temperature information piece detected by the temperature sensor is wirelessly transmitted to the carbody, and power supplies for this wireless transmission are also arranged at the bogie. When the power supplies are arranged at the bogie, the number of power supplies becomes large. Therefore, an increase in life of the power supply or a reduction in size of the power supply are also desired. If power consumption is reduced by, for example, simply reducing an operating frequency of the temperature sensor, an information amount regarding the abnormality of the bearing decreases, and therefore, the state of the bearing cannot be recognized accurately. The same is true for a case where information other than the temperature of the bearing is monitored as a monitoring target of the bogie.

An object of the present invention is to, in a railcar including a bogie at which a power supply is provided, suitably realize both an increase in life or a reduction in capacity of the power supply by a reduction in power consumption and a securement of an adequate information amount of state information pieces indicating an abnormality or an abnormality sign.

### Solution to Problem

A state monitoring device of a railcar according to one aspect of the present invention is a state monitoring device of a railcar including a carbody and a bogie, the state monitoring device including: a monitoring sensor provided at the bogie and configured to detect state information pieces of a machine part of the bogie; a wireless transmission unit provided at the bogie and configured to wirelessly transmit signals at a transmission interval, the signals containing the state information pieces detected by the monitoring sensor; and a power supply provided at the bogie and configured to supply electric power to the monitoring sensor and the wireless transmission unit. When it is determined that a monitored value based on the state information piece is not more than a threshold, the wireless transmission unit wirelessly transmits the signals at the transmission interval that is a predetermined initial interval. When it is determined that the monitored value has exceeded the threshold, the wireless transmission unit wirelessly transmits the signals at the transmission interval that is a narrow interval narrower than the initial interval.

According to the above configuration, when the monitored value does not exceed the threshold, the transmission interval of the wireless transmission unit is set to be wide, so that the power consumption by the wireless transmission can be reduced. Especially, since the power consumption by the wireless transmission is typically larger than the power consumption by the detection of the monitoring sensor, electric power saving can be effectively realized. Then, when the monitored value exceeds the threshold, the transmission interval of the wireless transmission unit is set to be narrow, so that the adequate amount of state information pieces indicating the abnormality or abnormality sign of the machine part of the bogie can be transmitted. Therefore, in the railcar in which the power supply is provided at the bogie, an increase in life or a reduction in capacity of the power supply by a reduction in power consumption and a securement of the adequate amount of state information pieces indicating the abnormality or the abnormality sign can be suitably realized at the same time.

### Advantageous Effects of Invention

According to the present invention, in a railcar in which a power supply is provided at a bogie, an increase in life or a reduction in capacity of the power supply by a reduction in power consumption and a securement of an adequate amount of state information pieces indicating an abnormality or an abnormality sign can be suitably realized at the same time.

### BRIEF DESCRIPTION OF DRAWINGS

FIG. 1 is a schematic diagram of a railcar on which a bearing monitoring device according to an embodiment is mounted.

FIG. 2 is a block diagram of a bearing temperature sensor unit of the bearing monitoring device shown in FIG. 1.

FIG. 3 is a block diagram of a carbody mounting device of the bearing monitoring device shown in FIG. 1.

FIG. 4 is a flow chart of the bearing monitoring device shown in FIGS. 2 and 3.

FIG. 5 is a conversion table for thresholds of a temperature rise amount based on a load of a bearing and a rotational speed of the bearing.

FIG. 6 is a conversion table for thresholds of a temperature rise rate based on the load of the bearing and the rotational speed of the bearing.

FIG. 7 is a conversion table for a transmission interval and an abnormality level based on the temperature rise amount or the temperature rise rate.

### DESCRIPTION OF EMBODIMENTS

Hereinafter, an embodiment will be explained with reference to the drawings.

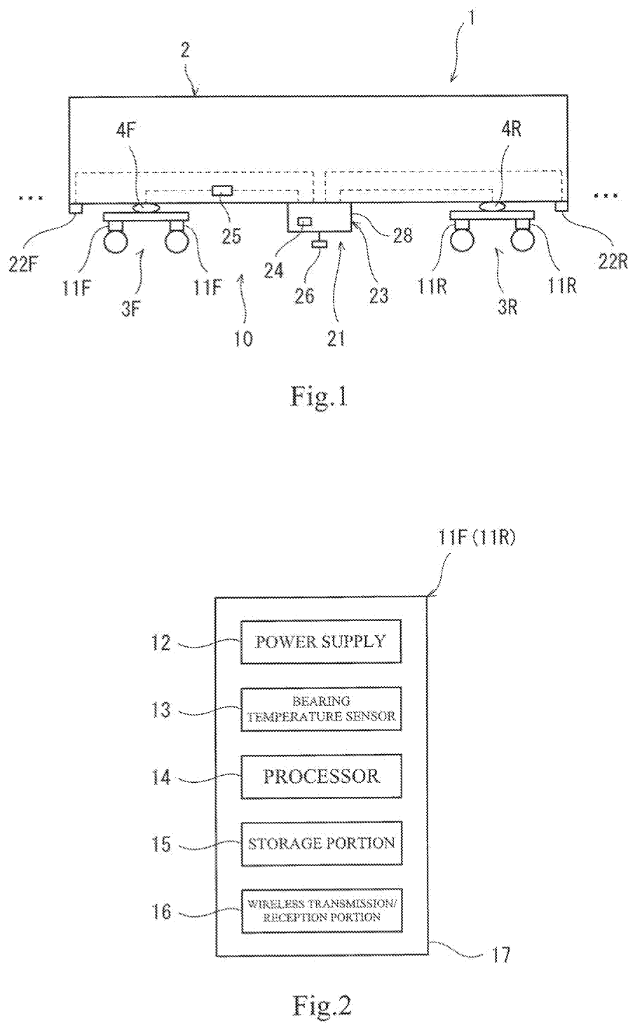

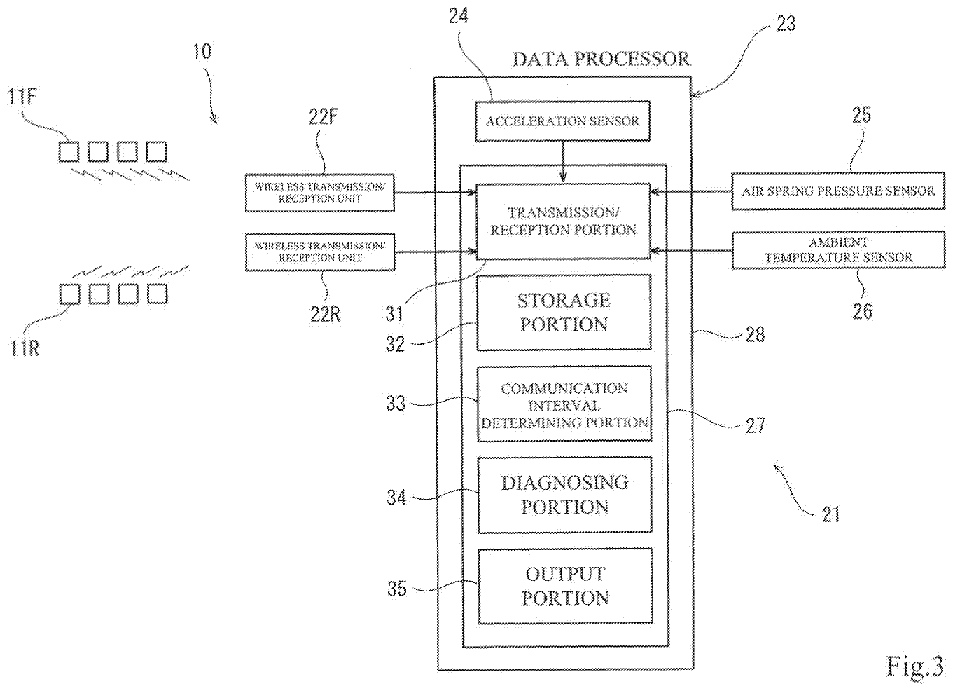

FIG. 1 is a schematic diagram of a railcar 1 on which a bearing monitoring device 10 according to the embodiment is mounted. FIG. 2 is a block diagram of a bearing temperature sensor unit 11F (11R) of the bearing monitoring device 10 shown in FIG. 1. FIG. 3 is a block diagram of a carbody mounting device 21 of the bearing monitoring device 10 shown in FIG. 1. As shown in FIG. 1, the railcar 1 includes a carbody 2, a first bogie 3F, and a second bogie 3R. The first bogie 3F is arranged close to one of longitudinal direction end portions of the carbody 2 and supports the carbody 2, and the second bogie 3R is arranged close to the other longitudinal direction end portion of the carbody 2 and supports the carbody 2. A first air spring 4F is interposed between the carbody 2 and the bogie 3F, and a second air spring 4R is interposed between the carbody 2 and the bogie 3R. FIG. 1 shows only one car, but needless to say, the railcar may include two or more cars.

The bearing monitoring device 10 as one example of a state monitoring device is mounted on the railcar 1. The bearing monitoring device 10 is a device configured to, while referring to applied loads (hereinafter simply referred to as “loads”) and rotational speeds of bearings (machine parts) accommodated in axle boxes of the bogies 3F and 3R, monitor the temperatures of the bearings to detect abnormalities of the bearings or abnormality signs of the bearings. The bearing monitoring device 10 includes the bearing temperature sensor units 11F and 11R and the carbody mounting device 21. The bearing temperature sensor units 11F are attached to the respective axle boxes of the first bogie 3F, and the bearing temperature sensor units 11F are attached to the respective axle boxes of the second bogie 3R. The carbody mounting device 21 is mounted on the carbody 2.

As shown in FIGS. 1 and 2, each of the bearing temperature sensor units 11F and 11R includes a power supply 12, a bearing temperature sensor 13, a processor 14, a storage portion 15, and a wireless transmission/reception portion 16. The power supply 12 is, for example, a battery. The power supply 12 may be, for example, a power supply which utilizes an energy harvest technology of collecting energy, such as vibration, heat, or sunlight, to obtain electric power. The bearing temperature sensor 13 detects the temperature of the bearing. Four bearing temperature sensors are provided at each bogie, and the temperatures of all the bearings of each bogie are detected. The bearing temperature sensor 13 contacts the bearing to directly detect the temperature of the bearing. However, for example, the bearing temperature sensor 13 may indirectly detect the temperature of the bearing by contacting the axle box instead of the bearing to detect the temperature of the axle box.

The processor 14 controls a read/write operation of the storage portion 15, an operation of the wireless transmission/reception portion 16, and the like. The storage portion 15 stores, for example, temperature information pieces (state information pieces) detected by the bearing temperature sensor 13. The wireless transmission/reception portion 16 wirelessly transmits the temperature information pieces stored in the storage portion 15 and receives a wireless signal from the carbody mounting device 21. According to each of the bearing temperature sensor units 11F and 11R in the present embodiment, the power supply 12, the bearing temperature sensor 13, the processor 14, the storage portion 15, and the wireless transmission/reception portion 16 are integrated by a casing 17, and the casing 17 is attached to the axle box.

As shown in FIGS. 1 and 3, the carbody mounting device 21 includes a pair of wireless transmission/reception units 22F and 22R, a data processor 23, an air spring pressure sensor 25, and an ambient temperature sensor 26. The data processor 23 includes an acceleration sensor 24. The wireless transmission/reception unit 22F provided at one end portion of the carbody 2 receives sensor signals wirelessly transmitted from the four wireless transmission/reception portions 16 of the first bogie 3F. The second wireless transmission/reception unit 22R provided at the other end portion of the carbody 2 receives sensor signals wirelessly transmitted from the four wireless transmission/reception portions 16 of the second bogie 3R.

The data processor 23 is provided at the carbody 2 and connected to the wireless transmission/reception units 22F and 22R through communication lines. Data pieces stored in the data processor 23 are accessible from the outside, and for example, are extractable through a communication line (not shown), a recording medium, or the like. The data processor 23 includes the acceleration sensor 24 and a data processing unit 27, and the data processing unit 27 is accommodated in a casing 28 together with the acceleration sensor 24. The casing 28 is attached to the carbody 2 and arranged under a floor of the carbody 2. The acceleration sensor 24 detects acceleration in a car longitudinal direction, i.e., acceleration in a car traveling direction. The acceleration sensor 24 is used when the data processor 23 calculates the rotational speeds of the bearings of the bogies 3F and 3R.

The air spring pressure sensor 25 is provided at the carbody 2 and detects an internal pressure value of the first air spring 4F interposed between the carbody 2 and the first bogie 3. The air spring pressure sensor 25 is connected to the data processor 23 and is used when the data processor 23 calculates the loads of the bearings of the first bogie 3F and the second bogie 3R. The ambient temperature sensor 26 is connected to the data processor 23 and detects an ambient temperature outside the railcar 1. For example, the ambient temperature sensor 26 is arranged under the casing 28 of the data processor 23.

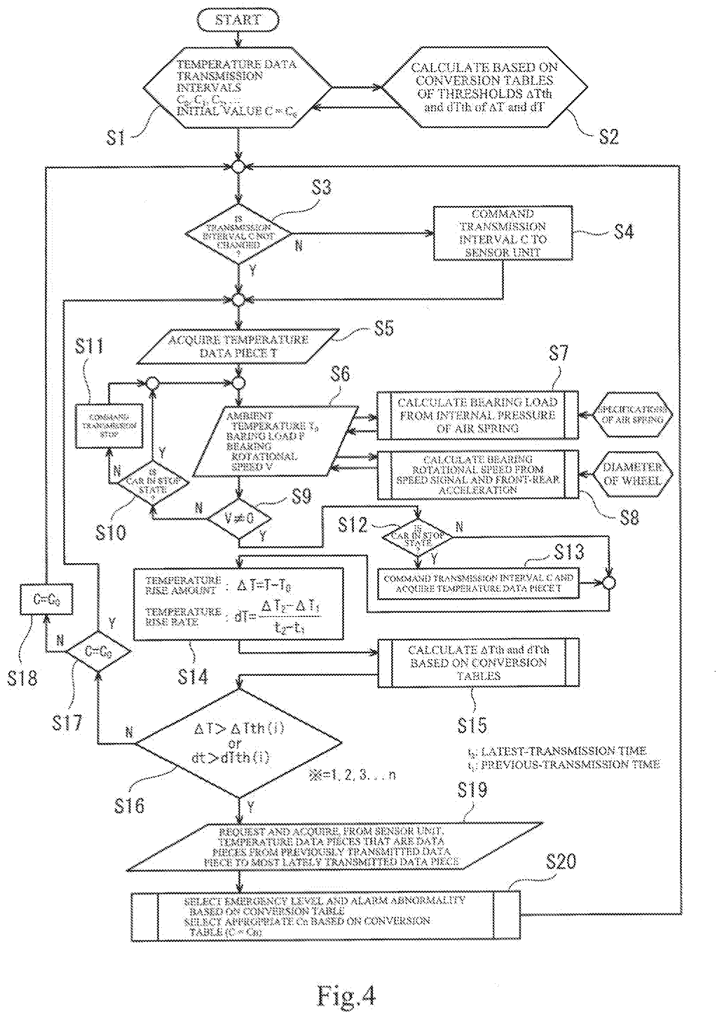

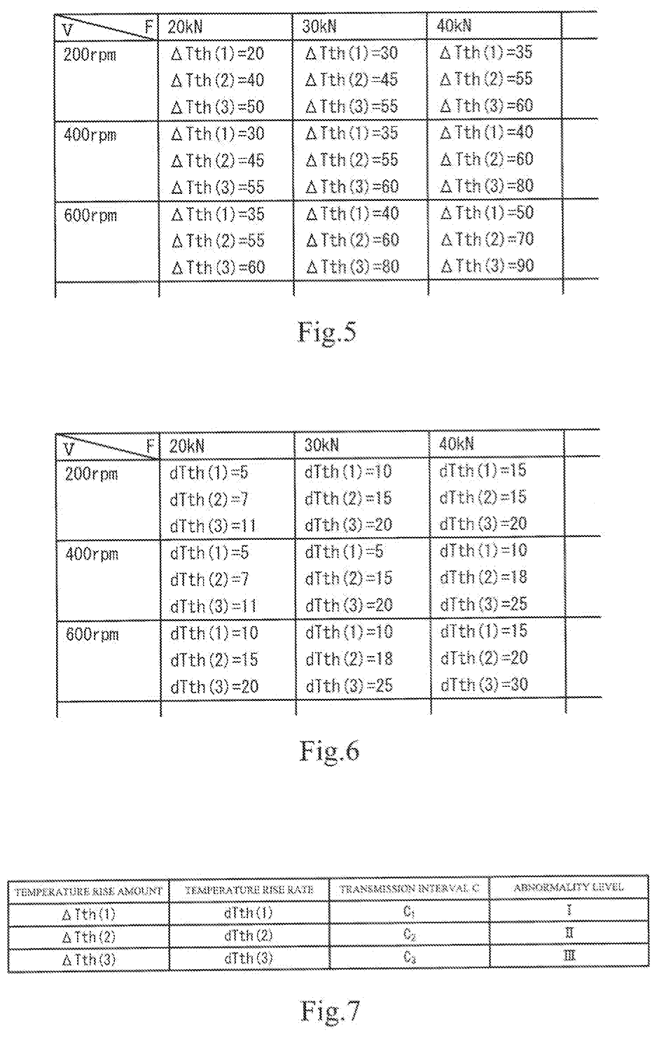

The data processing unit 27 includes a processor, a volatile memory, a non-volatile memory, an I/O interface, and the like. The data processing unit 27 includes a transmission/reception portion 31, a storage portion 32, a communication interval determining portion 33, a diagnosing portion 34, and an output portion 35. The transmission/reception portion 31 and the output portion 35 are realized by the I/O interface. The storage portion 32 is realized by the volatile memory and the non-volatile memory. The non-volatile memory of the storage portion 32 stores, for example, a program for executing a flow chart of FIG. 4 and conversion tables of FIGS. 5 to 7 described below. The communication interval determining portion 33 and the diagnosing portion 34 are realized by the processor performing calculations by using the volatile memory in accordance with the program stored in the non-volatile memory of the storage portion 32.

The transmission/reception portion 31 receives information of the temperatures of the bearings wirelessly received by the wireless transmission/reception unit 22F from the bearing temperature sensor units 11F and information of the temperatures of the bearings wirelessly received by the wireless transmission/reception unit 22R from the bearing temperature sensor units 11R. The transmission/reception portion 31 receives a data piece of the acceleration in the car traveling direction from the acceleration sensor 24. The transmission/reception portion 31 receives a data piece of the internal pressure value of the first air spring 4F from the air spring pressure sensor 25. The transmission/reception portion 31 receives a data piece of the ambient temperature outside the car from the ambient temperature sensor 26. The storage portion 32 stores the data pieces received by the transmission/reception portion 31.

The communication interval determining portion 33 determines a transmission interval of the wireless transmission/reception portions 16 of the bearing temperature sensor units 11F and 11R based on a procedure of the flow chart of FIG. 4 described below. The transmission interval of the wireless transmission/reception portions 16 determined by the communication interval determining portion 33 is wirelessly transmitted as a command value from the wireless transmission/reception units 22F and 22R to the wireless transmission/reception portions 16 of the bearing temperature sensor units 11F. The diagnosing portion 34 diagnoses the states of all the bearings of the first bogie 3F and the second bogie 3R based on the data pieces stored in the storage portion 32. The output portion 35 outputs a determination result of the diagnosing portion 34 to the outside through a predetermined mode (such as transmission, display, or sound).

FIG. 4 is a flow chart of the bearing monitoring device 10 shown in FIGS. 2 and 3. FIG. 5 is a conversion table for thresholds ΔTₜₕ(i) of a temperature rise amount ΔT based on a bearing load F and a bearing rotational speed V. FIG. 6 is a conversion table for thresholds dTₜₕ(i) of a temperature rise rate dT based on the bearing load F and the bearing rotational speed V. FIG. 7 is a conversion table for transmission intervals Cₙ and abnormality levels I to III based on the temperature rise amount ΔT or the temperature rise rate dT. Hereinafter, processing details of the bearing monitoring device 10 will be explained in accordance with the flow chart of FIG. 4 while suitably referring to, for example, FIGS. 5 to 7. For convenience of explanation, only the bearing temperature sensor unit 11F will be explained.

In the following explanation, ΔT denotes the temperature rise amount (° C.), ΔTₜₕ(1) denotes a first threshold of the temperature rise amount, ΔTₜₕ(2) denotes a second threshold of the temperature rise amount, ΔTₜₕ(3) denotes a third threshold of the temperature rise amount, dT denotes the temperature rise rate, dTₜₕ(1) denotes a first threshold of the temperature rise rate, dTₜₕ(2) denotes a second threshold of the temperature rise rate, dTₜₕ(3) denotes a third threshold of the temperature rise rate, C denotes the transmission interval, C₀ denotes an initial interval, Cᵢ denotes a first narrow interval, C₂ denotes a second narrow interval, C₃ denotes a third narrow interval, V denotes the bearing rotational speed, and F denotes the bearing load. Magnitude relations of these values are shown by Formulas 1 to 3 below.

ΔTₜₕ(1)<ΔTₜₕ(2)<ΔTₜₕ(3) (Formula 1)

dTₜₕ(1)<dTₜₕ(2)<dTₜₕ(3) (Formula 2)

C₀>C₁>C₂>C₃ (Formula 3)

First, when the bearing monitoring device 10 starts operating, the communication interval determining portion 33 sets the transmission interval C of the wireless transmission/reception portion 16 to the initial interval C₀ (Step S1). As shown in the conversion table of FIG. 7, when the temperature rise amount ΔT is not more than the first threshold ΔTₜₕ(1), or the temperature rise rate dT is not more than the first threshold dTₜₕ(1), the communication interval determining portion 33 maintains the transmission interval C at the initial interval C₀. When the temperature rise amount ΔT exceeds the first threshold ΔTₜₕ(1), or the temperature rise rate dT exceeds the first threshold dTₜₕ(1), the communication interval determining portion 33 sets the transmission interval C to the first narrow interval C₁. When the temperature rise amount ΔT exceeds the second threshold ΔTₜₕ(2), or the temperature rise rate dT exceeds the second threshold dTₜₕ(2), the communication interval determining portion 33 sets the transmission interval C to the second narrow interval C₂. When the temperature rise amount ΔT exceeds the third threshold ΔTₜₕ(3), or the temperature rise rate ΔdT exceeds the third threshold dTₜₕ(3), the communication interval determining portion 33 sets the transmission interval C to the third narrow interval C₃ (Step S2).

At this time, the first to third thresholds ΔTₜₕ(i) of the temperature rise amount ΔT are set with reference to the conversion table of FIG. 5, and the first to third thresholds dTₜₕ(i) of the temperature rise rate dT are set with reference to the conversion table of FIG. 6 (i is a natural number of 1 to 3). For example, when the bearing rotational speed V is not more than 200 rpm, and the bearing load is not more than 20 kN, the first threshold ΔTₜₕ(1), second threshold ΔTₜₕ(2), and third threshold ΔTₜₕ(3) of the temperature rise amount ΔT are set to “20,” “40,” and “50,” respectively, and the first threshold dTₜₕ(1), second threshold dTₜₕ(2), and third threshold dTₜₕ(3) of the temperature rise rate ΔdT are set to “5,” “7,” and “11,” respectively. As shown in FIG. 5, when the bearing load F increases, the first to third thresholds ΔTₜₕ(i) of the temperature rise amount ΔT are increased. When the bearing rotational speed V increases, the first to third thresholds ΔTₜₕ(i) of the temperature rise amount ΔT are increased. Further, as shown in FIG. 6, when the bearing load F increases, the first to third thresholds dTₜₕ(i) of the temperature rise rate dT are increased. When the bearing rotational speed V increases, the first to third thresholds dTₜₕ(i) of the temperature rise rate dT are increased.

Next, it is determined whether or not the transmission interval C set by the communication interval determining portion 33 has been changed (Step S3). When it is determined that the transmission interval C has been changed, the data processor 23 transmits information of the transmission interval C determined by the communication interval determining portion 33 to the bearing temperature sensor unit 11F, and the processor 14 sets the transmission interval C of the wireless transmission/reception portion 16 in accordance with the information (Step S4). When it is determined in Step S3 that the transmission interval C has not been changed, or after Step S4, the data processing unit 27 acquires a temperature data piece T transmitted from the bearing temperature sensor unit 11F (Step S5).

The bearing temperature sensor 13 detects the temperature information pieces of the bearing at a sampling interval narrower than the initial interval C₀, and the storage portion 15 has a capacity that stores at least a plurality of temperature information pieces detected within the initial interval C₀. In the present embodiment, the sampling interval of the bearing temperature sensor 13 is narrower than each of the transmission intervals C (C₀, C₁, C₂, and C₃). When the transmission interval C is set to the initial interval C₀, the wireless transmission/reception portion 16 wirelessly transmits only some of the plurality of temperature information pieces detected within the initial interval C₀ and stored in the storage portion 15. For example, the wireless transmission/reception portion 16 wirelessly transmits only the latest one of the plurality of temperature information pieces within the initial interval C₀ stored in the storage portion 15.

Further, the data processor 23 acquires an ambient temperature T₀, the bearing load F, and the bearing rotational speed V (Step S6). The ambient temperature T₀ is detected by the ambient temperature sensor 26. The bearing load F is calculated by using an internal pressure value P of the first air spring 4F detected by the air spring pressure sensor 25 (Step S7). Specifically, the data processing unit 27 calculates the bearing load F by Formula 4 below. Herein, A denotes a pressure receiving area of the air spring, and W denotes the weight of members interposed between the air spring and the bearing in the bogie.

F=(P·A+W/2)/2 (Formula 4)

The bearing rotational speed V is calculated from acceleration Acc in the car traveling direction detected by the acceleration sensor 24 (Step S8). Specifically, the data processing unit 27 calculates the bearing rotational speed V by Formula 5 below. Herein, D denotes the diameter of a wheel of the bogie, and π denotes the ratio of the circumference of a circle to its diameter.

V=∫Acc·dt/(πD) (Formula 5)

Next, it is determined whether or not the bearing rotational speed V is zero (Step S9). When it is determined that the bearing rotational speed V is zero, it is determined whether or not the car was already in a stop state (Step S10). When it is determined that the car was already in a stop state, the process returns to Step S6. When it is determined that the car was not in a stop state, the data processing unit 27 commands a transmission stop to the bearing temperature sensor unit 11F to stop the wireless transmission of the temperature information pieces from the wireless transmission/reception portion 16 (Step S11), and the process returns to Step S6.

When it is determined in Step S9 that the bearing rotational speed V is not zero, it is determined whether or not the car was already in a stop state (Step S12). When it is determined that the car was already in a stop state, the data processing unit 27 commands the transmission interval C determined by the communication interval determining portion 33 to the bearing temperature sensor unit 11F and wirelessly receives the temperature data piece T from the bearing temperature sensor unit 11F (Step S13), and the process proceeds to Step S14. When it is determined that the car was not in a stop state, the process proceeds to Step S14.

Next, the communication interval determining portion 33 calculates the temperature rise amount ΔT (=T−T₀) and the temperature rise rate dT (=(ΔT₂−ΔT₁)/(t₂−tᵢ)) (Step S14). Herein, T denotes the detected bearing temperature (° C.), t₂ denotes a latest-transmission time, t1 denotes a previous-transmission time, ΔT₂ denotes ΔT at the time t₂, and ΔT₁ denotes ΔT at the time t1. The communication interval determining portion 33 determines the first to third thresholds ΔTₜₕ(i) and the first to third thresholds dTₜₕ(i) based on the conversion tables of FIGS. 5 and 6 (Step S15). Then, the communication interval determining portion 33 determines whether or not at least one of Conditions 1 and 2 below is satisfied.

ΔT>ΔTₜₕ(i) (Condition 1)

dT>dTₜₕ(i) (Condition 2)

When it is determined that Conditions 1 and 2 are not satisfied, it is determined whether or not the transmission interval C is the initial interval C₀ (Step S17). When it is determined that the transmission interval C was already the initial interval C₀, the process returns to Step S3. When it is determined that the transmission interval C was not the initial interval C₀, the communication interval determining portion 33 determines the transmission interval C as the initial interval C₀ and wirelessly commands that the bearing temperature sensor unit 11F sets the transmission interval C to the initial interval C₀ (Step S18).

When it is determined that at least one of Conditions 1 and 2 is satisfied, the data processing unit 27 requests the bearing temperature sensor unit 11F to wirelessly transmit a plurality of (for example, all) temperature data pieces that are temperature data pieces from a previously transmitted temperature data piece to a most lately transmitted temperature data piece stored in the storage portion 15, and then receives these temperature data pieces (Step S19). The communication interval determining portion 33 determines an emergency level based on the conversion table of FIG. 7 and alarms an abnormality, and also changes the transmission interval C (Step S20). Regarding the emergency level, “I” denotes an abnormality sign, “II” denotes slight abnormality, and “III” denotes serious abnormality.

Specifically, when the temperature rise amount ΔT exceeds the first threshold ΔTₜₕ(1), or when the temperature rise rate dT exceeds the first threshold dTₜₕ(1), the diagnosing portion 34 determines “I” as the emergency level, and the output portion 35 outputs a warning to the outside. In addition, the communication interval determining portion 33 commands that the bearing temperature sensor unit 11F changes the transmission interval C to the first narrow interval C₁. In the bearing temperature sensor unit 11F which has received the command, the processor 14 sets the transmission interval C of the wireless transmission/reception portion 16 to the first narrow interval C₁. When the temperature rise amount ΔT exceeds the second threshold ΔTₜₕ(2), or when the temperature rise rate dT exceeds the second threshold dTₜₕ(2), “II” is determined as the emergency level, and the transmission interval C of the wireless transmission/reception portion 16 is changed to the second narrow interval C₂. When the temperature rise amount ΔT exceeds the third threshold ΔTₜₕ(3), or when the temperature rise rate dT exceeds the third threshold dTₜₕ(3), “III” is determined as the emergency level, and the transmission interval C of the wireless transmission/reception portion 16 is changed to the third narrow interval C₃. After Step S20, the process returns to Step S3.

According to the above-explained configuration, when a monitored value (the temperature rise amount ΔT or the temperature rise rate dT) does not exceed the first to third thresholds ΔTₜₕ(i) or dTₜₕ(i), the transmission interval C of the wireless transmission/reception portion 16 is set to be wide, so that the power consumption by the wireless transmission can be reduced. Especially, since the power consumption by the wireless transmission is typically larger than the power consumption by the detection of the bearing temperature sensor 13, electric power saving can be effectively realized. Then, when the monitored value (the temperature rise amount ΔT or the temperature rise rate dT) exceeds the first to third thresholds ΔTₜₕ(i) or dTₜₕ(i), the transmission interval C of the wireless transmission/reception portion 16 is set to be narrow, so that the adequate amount of temperature information pieces indicating the abnormality or abnormality sign of the bearing of the bogie can be transmitted. Therefore, in the railcar 1 in which the power supplies 12 are provided at the bogies 3F and 3R, an increase in life or a reduction in capacity of the power supply 12 by a reduction in power consumption and a securement of the adequate amount of temperature information pieces indicating the abnormality or the abnormality sign can be suitably realized at the same time.

Further, when the monitored value (the temperature rise amount ΔT or the temperature rise rate dT) does not exceed the first threshold ΔTₜₕ(1) or dTₜₕ(1), only some of the plurality of temperature data pieces that are temperature data pieces from the previously transmitted temperature data piece to the most lately transmitted temperature data piece stored in the storage portion 15 are wirelessly transmitted, so that this contributes to a reduction in the amount of information transmitted and a reduction in the power consumption. On the other hand, when the monitored value (the temperature rise amount ΔT or the temperature rise rate dT) exceeds the first threshold ΔTₜₕ(1) or dTₜₕ(1), the plurality of temperature data pieces that are temperature data pieces from the previously transmitted temperature data piece to the most lately transmitted temperature data piece stored in the storage portion 15 at the time of this exceeding of the monitored value are wirelessly transmitted, so that the temperature data pieces immediately before the occurrence of the abnormality or the abnormality sign can be wirelessly transmitted in detail, and this can contribute to the study of the cause of the occurrence of the abnormality or the abnormality sign.

Further, two types of physical quantities that are the temperature rise amount ΔT and the temperature rise rate dT are used as the monitored values, and when at least one of the temperature rise amount ΔT and the temperature rise rate dT exceeds the first to third thresholds ΔTₜₕ(i) or dTₜₕ(i), the transmission interval C is changed, and the emergency level is determined. Therefore, the occurrence of the abnormality or abnormality sign of the bearing can be accurately monitored.

Further, when at least one of the bearing load F and the bearing rotational speed V increases, the temperature rise amount ΔT and the temperature rise rate dT tend to increase even if the bearing is normal. Therefore, by increasing the first to third thresholds ΔTₜₕ(i) and dTₜₕ(i) when at least one of the bearing load and the bearing rotational speed increases, the transmission interval C of the wireless transmission/reception portion 16 can be prevented from narrowing when the bearing is normal. When it is not a case where at least one of the bearing load F and the bearing rotational speed V is high, the temperature rise amount ΔT and the temperature rise rate dT are relatively small even if the abnormality of the bearing occurs. Therefore, by reducing the first to third thresholds ΔTₜₕ(i) and dTₜₕ(i), the abnormality or abnormality sign of the bearing can be accurately detected.

It is thought that the abnormality of the bearing hardly occurs when the railcar 1 is in a stop state. Since the wireless transmission/reception portion 16 stops the wireless transmission when the bearing rotational speed V is zero, the power consumption can be effectively reduced.

The present invention is not limited to the above embodiment, and modifications, additions, and eliminations may be made with respect to the configuration of the present invention. For example, in the present embodiment, a value based on the temperature of the bearing is used as the monitored value. However, the present embodiment is not limited to this as long as the monitored value is a physical quantity indicating the state of the machine part of the bogie. For example, vibration of the bearing of the bogie, a state information piece of the plate spring of the bogie, or the like may be used. Further, in the present embodiment, both the temperature rise amount ΔT and the temperature rise rate dT are monitored as the monitored values. However, only one of the temperature rise amount ΔT and the temperature rise rate dT may be monitored. The communication interval determining portion 33 is provided at the data processing unit 27 in the present embodiment but may be provided at the bearing temperature sensor unit 11F.

The conversion tables of FIGS. 5 to 7 are just examples, and specific numerical values of the conversion tables are suitably determined in accordance with specifications. The threshold may be changed based on a formula including the bearing load and the bearing rotational speed as inputs, instead of based on the conversion table. Further, in the present embodiment, the air spring pressure sensor 25 is used as a state sensor used for calculating the bearing load F. However, the present embodiment is not limited to this. For example, the bearing load F may be detected by using a load cell. In the present embodiment, the acceleration sensor 24 is used as a state sensor used for calculating the bearing rotational speed V. However, the present embodiment is not limited to this. For example, the bearing rotational speed V may be detected by using a vehicle speed sensor.

In the present embodiment, only the transmission interval of the wireless transmission/reception portion 16 is changed. However, the sampling frequency of the bearing temperature sensor 13 may also be changed for further improving the electric power saving of the bearing temperature sensor unit 11F. To be specific, when it is determined that the monitored value is not more than the threshold, the processor may set the sampling interval of the bearing temperature sensor 13 to a predetermined initial interval, and when it is determined that the monitored value has exceeded the threshold, the processor may set the sampling interval of the bearing temperature sensor 13 to a narrow interval narrower than the initial interval. In the present embodiment, the monitored value to be compared with the threshold is the temperature rise amount ΔT or the temperature rise rate dT. However, both the temperature rise amount ΔT and the temperature rise rate dT may be used as the monitored values.

### REFERENCE SIGNS LIST

1 railcar

2 carbody

3F, 3R bogie

10 bearing monitoring device

12 power supply

13 bearing temperature sensor (monitoring sensor)

14 processor

15 storage portion (storage unit)

16 wireless transmission/reception portion (wireless transmission unit)

32 storage portion (second storage unit)

33 communication interval determining portion (communication interval determining unit)

34 diagnosing portion (diagnosing unit)

1. A state monitoring device of a railcar including a carbody and a bogie,
the state monitoring device comprising:
a monitoring sensor provided at the bogie and configured to detect state information pieces of a machine part of the bogie;
a wireless transmission unit provided at the bogie and configured to wirelessly transmit signals at a transmission interval, the signals containing the state information pieces detected by the monitoring sensor; and
a power supply provided at the bogie and configured to supply electric power to the monitoring sensor and the wireless transmission unit, wherein:
when it is determined that a monitored value based on the state information piece is not more than a threshold, the wireless transmission unit wirelessly transmits the signals at the transmission interval that is a predetermined initial interval; and
when it is determined that the monitored value has exceeded the threshold, the wireless transmission unit wirelessly transmits the signals at the transmission interval that is a narrow interval narrower than the initial interval.

2. The state monitoring device according to claim 1, further comprising a storage unit provided at the bogie and configured to store the state information pieces, wherein:
the monitoring sensor detects the state information pieces at a sampling interval narrower than the initial interval;
the storage unit has a capacity that stores at least the plurality of state information pieces detected within the initial interval;
when the transmission interval is set to the initial interval, the wireless transmission unit wirelessly transmits some of the plurality of state information pieces detected within the initial interval and stored in the storage unit; and
when the transmission interval is changed from the initial interval to the narrow interval, the wireless transmission unit wirelessly transmits the plurality of state information pieces stored in the storage unit at the time of this change of the transmission interval.

3. The state monitoring device according to claim 1, wherein:
the monitoring sensor is a bearing temperature sensor configured to detect temperature information pieces of a bearing of the bogie as the state information pieces; and
the monitored value is at least one of a temperature rise amount and a temperature rise rate, the temperature rise amount and the temperature rise rate being obtained from the temperature information pieces.

4. The state monitoring device according to claim 3, further comprising a communication interval determining unit configured to determine a magnitude relation between the monitored value and the threshold and determine the transmission interval of the wireless transmission unit, wherein:
when at least one of a load of the bearing and a rotational speed of the bearing increases, the communication interval determining unit increases the threshold.

5. The state monitoring device according to claim 3, wherein when a rotational speed of the bearing is zero, the wireless transmission unit stops wireless transmission of the temperature information pieces.

6. The state monitoring device according to claim 1, further comprising:
a second storage unit provided at the carbody and configured to store data pieces of the signals transmitted from the wireless transmission unit; and
a diagnosing unit configured to diagnose a state of the machine part based on the data pieces stored in the second storage unit.
